(19) United States
(12) Patent Application Publication
(10) Pub. No.: US 2025/0340763 A1
(43) Pub. Date: Nov. 6, 2025

(54) THERMALLY DETACHABLE MULTILAYER COMPOSITIONS BONDED WITH THERMO-PLASTIC PRIMERS

(71) Applicants: Dow Global Technologies LLC, Midland, MI (US); Dow Silicones Corporation, Midland, MI (US)

(72) Inventors: Yongchun Chen, Shanghai (CN); Qingwei Meng, Shanghai (CN); Yi Zhang, Shanghai (CN); Hongyu Chen, Shanghai (CN); Qi Gao, Shanghai (CN); Yanbin Fan, Shanghai (CN); Shouxue Guo, Shanghai (CN); Jing Liu, Shanghai (CN); Shaoguang Feng, Shanghai (CN)

(21) Appl. No.: 18/867,065

(22) PCT Filed: Jun. 30, 2022
(86) PCT No.: PCT/CN2022/102798

§ 371 Date: Nov. 19, 2024

(51) Int. Cl. C09J 151/06; C08J 11/06

(52) U.S. Cl. CPC C09J 151/06; C08J 11/06; C09J 2203/33; C09J 2451/003

(57) ABSTRACT

Multilayer compositions include a substrate having a surface energy of 35 dynes/cm or greater; one or more thermoplastic primer layers comprising 55 wt % to 100 wt % of a maleic anhydride grafted chlorinated polyolefin and a glass transition temperature in the range of 50° C. to 120° C.; and one or more thermoset adhesive layers.

### FIELD

Embodiments relate to thermally detachable multilayer compositions bonded with thermoplastic primer layers and thermoset adhesives.

### INTRODUCTION

Thermoplastic adhesives and thermosetting adhesives are utilized in a number of industrial applications, including flexible packaging, and mounting electric vehicle (EV) batteries. For most applications, thermoset adhesives are selected on the basis of bonding strength, substate compatibility, and long term durability under operating conditions. For a number of applications, however, adhered components must be separated for reusability, recyclability, maintenance, or replacement of parts. In order to detach an EV battery cell bonded to a thermoset adhesive layer, for example, physical removal methods are typically used, such as prying, cutting, or laser ablation. Other approaches involve the use of solvents, alkalis, or acids to remove the thermoset adhesive by immersion, which can generate chemical hazards and may provide limited penetration into an adhesive layer. Another concern with common detachment methods is the effectiveness in high surface area attachments, including those present in EV battery packs, which can lead to damage to adhered components.

### SUMMARY

Multilayer compositions disclosed herein may include a substrate having a surface energy of 35 dynes/cm or greater; one or more thermoplastic primer layers comprising 55 wt % to 100 wt % of a maleic anhydride grafted chlorinated polyolefin and a glass transition temperature in the range of 50° C. to 120° C.; and one or more thermoset adhesive layers.

### DETAILED DESCRIPTION

Embodiments relate to thermally detachable multilayer compositions having one or more thermoplastic primer layers, and one or more thermoset adhesive layers that enable detachment of high surface energy substrates by heating. Thermoplastic primer layers disclosed herein may remain solid and maintain thermoset adhesive performance throughout operating temperatures for most applications (e.g., up to 50° C.), but soften and/or melt at temperatures near and above the glass transition temperature (T_{g}) or melt point temperature (Tₘ) of the thermoplastic primer layer (e.g., in a range of 50° C. to 130° C.).

Electric vehicle battery designs often include one or more battery packs containing a plurality of battery cells that are individually bonded to various types of substrates. EV batteries may also include a number of external features to protect battery packs and battery cell arrays, including a number of housings and substrates. With the large surface contact areas of battery components (e.g., around 0.5 m² for a pack block to 1.5 m² for a whole pack) and broad working temperature ranges (e.g., −20° C. to 60° C.), thermoset adhesives are often employed to provide bonding strength between the battery and underlying or above substrates and structures. The bonding strength of thermoset adhesives, however, makes it difficult to detach battery packs or pack substrates without damaging or deforming adhered components.

Multilayer compositions disclosed herein may incorporate one or more thermoplastic primer layers that enables detachment from a substrate upon the application of heat, particularly for applications in which thermoset adhesives are typically used, such as to mediate adhesion between a substrate (e.g., battery cell) and a thermal management plate (e.g., thermal or cooling sheet) or another substrate (e.g., battery pack cover, battery pack bottom). Multilayer compositions may incorporate thermoplastic maleic anhydride grafted chlorinated polyolefin (MAH-g-CPO), which mediates adhesion of a thermoset adhesive layer to a substrate having a surface energy of greater than 35 dynes/cm.

Thermoplastic primer layers and thermoset adhesive layers disclosed herein may maintain good bonding strength relative to a bond between an adhesive layer and a substrate without the primer layer. Multilayer compositions disclosed herein may have a lap shear strength at room temperature that having less than a 30% decrease relative to a comparative multilayer composition without a thermoplastic primer layer. Multilayer compositions disclosed herein may have a cross tensile strength at room temperature that having less than a 30% decrease relative to a comparative multilayer composition without a thermoplastic primer layer.

Thermoplastic primer layers disclosed herein may be detachably bonded to a thermoset adhesive layer and/or a substrate, such that the primer layer maintains bond strength at temperatures under or lower than 50° C., but melts or softens for facile detachment at elevated temperatures. For example, at elevated temperatures (e.g., above 50° C.), thermoplastic primer layer (or layers) melt or soften, facilitating detachment between the thermoplastic primer layer and the substrate and/or thermoset adhesive layer. Thermoplastic primer layers disclosed herein may have glass transition temperatures (T_{g}) that range from 50° C. to 130° C., 50° C. to 120° C., 55° C. to 120° C., 55° C. to 115° C., 55° C. to 100° C., or 60° C. to 80° C.

Multilayer compositions may include a high surface energy substrate onto which one or more thermoplastic primer layers and/or thermoset adhesive layers are formed, applied, or deposited. High surface energy substrates may include, for example, metal, epoxy, or polyacrylate surfaces used in EV battery packs, thermal management plates, and other industrial applications.

As used herein, “high surface energy substrate” refers to substrates having a surface energy of 35 dynes/cm or greater, and exclude substrates with <35 dynes/cm surface free energy. High surface energy substrates disclosed herein include metals such as aluminum, steel or alloys, zinc, and the like, non-metals, including glass, polar polymers such as epoxy, polyurethane, polyester, and the like.

Table 1 includes additional examples of suitable high surface energy substrates.

TABLE 1
Surface energy measurements for selected substrates

| | Surface Energy |
|---|---|
| Substrate | (dynes/cm) |
| Copper | 1103 |
| Aluminum | 840 |
| Zinc | 753 |
| Tin | 526 |
| Lead | 458 |
| Stainless Steel | 700-1100 |
| Glass | 250-500 |
| Polyimide | 50 |
| Epoxy | 43 |
| Phenolic | 47 |
| Nylon | 46 |
| ABS | 42 |
| Polyether sulfone | 46 |
| Styrene butadiene rubber | 48 |
| Polycarbonate | 46 |
| Polyethylene terephthalate | 43 |
| Polyurethane | 43 |

In some cases, high surface energy substrates may also be placed into contact with a multilayer composition containing one or more thermoplastic primer layers and/or thermoset adhesive layers that are assembled on a second substrate or surface. In some cases, multilayer composition may contain a thermoplastic primer layer contacting a high surface energy substrate, and a thermoset adhesive contacting the thermoplastic primer layer. The thermoset adhesive may also mediate adhesion to a second substrate, such as a thermal management plate.

In another example, a multilayer composition may contain a first thermoplastic primer layer contacting a high surface energy substrate, and a thermoset adhesive layer contacting the first thermoplastic primer layer. A second thermoplastic primer layer may be in contact the thermoset adhesive layer and mediate adhesion to a second substrate.

Multilayer compositions may include one or more thermoset adhesive layers, which can include one or more polyurethane, epoxy, polyacrylate, polyester, crosslinked derivatives thereof, and the like. Thermoset adhesives include polar thermoset adhesives having a surface energy of 35 dynes/cm or more. In an example, the thermoset adhesive layer may include a methylene diphenyl diisocyanate (MDI)-based 2K polyurethane structural adhesive. Thermoset adhesives disclosed herein may be water-borne, solvent-borne, or solventless.

Multilayer compositions disclosed herein may contain one or more thermoplastic primer layers include a maleic anhydride grafted chlorinated polyolefin (MAH-g-CPO) alone or in combination with an additional thermoplastic polymers. Maleic anhydride grafted chlorinated polyolefins disclosed herein may have a maleic anhydride grafting degree of greater than 1% and a chlorination degree content of greater than 10%. In some cases, maleic anhydride grafted chlorinated polyolefins may have a chlorination degree of 10% to 30%, and/or at least one maleic anhydride degree of 1% to 5%. Maleic anhydride grafted chlorinated polyolefins disclosed herein may have a weight average molecular weight of 50,000 Da or more, 60,000 Da or more, or 100,000 or more. Maleic anhydride grafted chlorinated polyolefins may have a weight average molecular weight of in a range of 40,000 Da to 100,000 Da, 50,000 Da to 90,000 Da, or 50,000 Da to 80,000 Da.

Thermoplastic primer layers may contain a MAH-g-CPO combined with one or more additional thermoplastic polymers, including thermoplastic polar polymer such as polyurethane or polyesters, or thermoplastic less-polar polymers such as maleic anhydride grafted polyolefin (MAH-g-POE), maleic anhydride grafted ethylene-vinyl acetate (MAH-g-EVA), ethylene-vinyl acetate (EVA), maleic anhydride grafted styrene-ethylene-butylene-styrene (MAH-g-SEBS), and the like. Thermoplastic primer layers may include polymer blends, including MAH-g-CPO combined with one or more additional polymers (e.g., more or less polar polymers) that modify the overall polarity of the blended layer.

The introduction of additional polymers into thermoplastic primer layers can modify the polarity and compatibility of the primer layer with thermoset adhesive layers or substrates, which can increase or decrease the corresponding interlayer bond strength at operating temperatures. For example, increasing the polarity of the thermoplastic primer layer can increase compatibility with a polar thermoset adhesive layer, increasing the bond strength at low temperatures. Conversely, by blending MAH-g-CPO with a less polar polymer in a thermoplastic primer layer will reduce the compatibility with the polar thermoset adhesive layer, reducing the bond strength and increasing the detachment properties at high temperature.

Thermoplastic primer layers incorporating multiple polymers may include a MAH-g-CPO component at a percent by weight (wt %) of 55 wt % or more, 60 wt % or more, or 70 wt % or more. Thermoplastic primer layers containing a mixture of resins may include MAH-g-CPO and one or more thermoplastic polymer components at a percent by weight (wt %) in a range of 0 wt % to 45 wt %, 0 wt % to 40 wt %, or 0 wt % to 30 wt %, with the balance as MAH-g-CPO and/or additives.

Thermoplastic primer layers may be applied to an adhesive layer and/or substrate layer as a solid or thin film (e.g., 100 wt % solids). Thermoplastic primer layers may be generated by solvating a MAH-g-CPO resin, optionally with one or more additional thermoplastic polymers, in a suitable solvent, and depositing the resulting solvated resin composition on a substrate or surface. The solvent is then allowed to evaporate as the thermoplastic primer layer is formed. Suitable solvents may vary depending on the solubility of the selected primer resin or resin mixture, and may include aqueous or organic solvents. Mixtures of nonpolar and polar organic solvents may be used. Nonpolar solvents may include cycloalkyl or aromatic species such as methyl cyclohexane, toluene, and the like. Polar organic solvents may include methyl ethyl ketone, ethyl acetate, butyl acetate, and the like.

Organic solvated resin compositions may include one or more primer resins (e.g., solids) at a percent by weight (wt %) in a range of 1 wt % to 35 wt %, 1 wt % to 20 wt %, or 3 wt % to 20 wt %. Organic solvated resin compositions may include a nonpolar organic solvent at a percent by weight (wt %) in a range of 60 wt % to 99 wt %, 65 wt % to 99 wt %, or 70 wt % to 99 wt %. Organic solvated resin compositions may include a polar organic solvent at a percent by weight (wt %) in a range of 1 wt % to 40 wt %, 1 wt % to 45 wt %, or 1 wt % to 30 wt %.

Aqueous solvated resin compositions may include one or more primer resins at a percent by weight (wt %) in a range of 15 wt % to 65 wt %, 20 wt % to 60 wt %, or 30 wt % to 55 wt %. Aqueous solvated resin compositions may include an aqueous fluid at a percent by weight (wt %) in a range of 35 wt % to 85 wt %, 40 wt % to 80 wt %, or 45 wt % to 70 wt %.

Methods of preparing detachable multilayer compositions disclosed herein may include providing a substrate surface, one or more thermoplastic primer layers, and one or more thermoset adhesive layers. Thermoplastic primer layers and thermoset adhesive layers may be produced by solid deposition or by coating from solvent composition using known methods such as roller coating, flow coating, dip coating, spin coating, spray coating, knife coating, and die coating. Multilayer compositions disclosed herein may include a thermoplastic primer layer having a thickness in a range of 3 μm to 150 μm, 5 μm to 100 μm, or 8 μm to 90 μm. Layer thickness may be measured by any suitable method including by PROGAGET thickness tester available from Thwing-ALBERT Instrument Company, in which layer thickness is determined after drying at room temperature for 1 day.

Methods of detaching a battery pack adhered to a substrate by a multilayer composition may include heating the multilayer composition to a “detachment temperature” above 50° C. to induce softening or melting of the thermoplastic primer layers, followed by separating one or more layers of the multilayer composition to detach the battery pack from the substrate. Detachment methods may include mechanically separating the primer and/or adhesive layer from the substrate layer by a suitable technique such as prying, wedging, and/or impact. In some cases, gravity or other “passive” technique may be used to separate one or more layers of the multilayered composition.

Application of heat to a multilayer composition may include use of an external heat source such as an electric heating platform, electric heating pad, electric heating sheet, electric heating blanket, or the like, or an internal heat source such as the thermal management plate, thermal management pad, embedded heat elements, and the like. Thermal management plates are often used to maintain EV batteries within a steady temperature range (e.g., between −20° C. to 50° C.). During operation, the thermal management plate operates to dissipate or supply heat to the EV battery by passive (e.g., heat sink) or active (e.g., utilizing a flowing fluid or gas) heat transfer. Methods disclosed herein may utilize a thermal management plate or other method for direct heating of the primer and adhesive layers to a detachment temperature (i.e., above the transition temperature of the thermoplastic primer layer), while also minimizing the heat transfer from the heat source to the battery pack and subsequent battery damage.

Detachment of the substrate from the thermoplastic primer layers and the thermoset adhesive layers may include heating a multilayer composition to a temperature equal to or greater than 50° C.; and removing at least one of the layers of the multilayer composition. Methods of delivering the heat can include thermal management plate, oven, heat gun, steam, microwave radiation, resistive heating, induction heating, and the like.

Solvent borne primers are prepared by solubilizing primer resin particles in a 85:5 mixture of methyl cyclohexane (MCH) and methyl ethyl ketone (MEK). Resin particles were added into the flask with designed solid contents (e.g., 1 wt %, 3.5 wt %, 5 wt %, 10 wt %, 15 wt % and 20 wt %) and heated to 80° C. under stirring until dissolved. After cooling to room temperature, the solvent borne primers were sealed and applied in the tests.

In the tests, the solvent borne primers are coated on substrates with different type and size, the thickness of the primer layer is controlled by the solid content of the primer or by the coated times. After drying, the surface treated substrates are applied in the lap shear strength, cross tensile strength, or lab-established detachable tests.

Lap shear strength testing was carried out according to GB/T 7124. Substrates tested included epoxy coated type-3 aluminum (3003), Type-3 aluminum (3003) and Type-5 aluminum (5754) with dimensions of 25 mm*100 mm*1.5 mm. Substrate surfaces were cleaned with ethanol and brush coated with primer layer sample solutions and dried. Thermoset adhesives were applied by mixing isocyanate components and isocyanate-reactive components under vacuum conditions, and 0.5 g to 1.5 g of adhesive was applied to the substrate. Along the length direction, a second substrate with the same bonding area was applied to the adhesive layer. Pressure was applied and the multilayer compositions were cured at 23° C. for 7 days. Lap shear strength was tested using an Instron testing system.

Cross tensile strength tests were carried out according to GB/T 6329. Substrates tested included epoxy coated Type-3 aluminum (3003) with a cylinder of 60 mm height and 15 mm diameter. Prior to treatment, the cylinder head surface was cleaned, and the thermoplastic primer composition was applied and dried. Comparative samples without primer treatment were also prepared. Adhesive compositions were then prepared and 0.5 g to 1.0 g was applied to the substrate. A second substrate was applied, and the flat surfaces of the substrates were bonded together by curing at 23° C. for 7 days. Cross tensile strength was measured by Instron tensile testing machine.

Detachment test was conducted with a lab-established qualitative method with the following process:
1) Substrate surfaces (100 mm*150 mm*2 mm) are cleaned by wiping off with ethanol.
2) Substrates are then coated with primer by brush, dried. Comparative samples were also prepared without primer treatment.
3) Thermoset adhesive layers were prepared by combining Part A and Part B of a 2K PU adhesive in speed mixer at 1,000 rpm for 1 min.
4) Approximately 10 g to 15 g of the adhesive is applied to the substrate using two copper wires with diameter 1 mm to control layer thickness.
5) A second substrate was then stacked lengthwise. The bonding surfaces of the substrate are then contacted and held in place with clips. The adhered substrates were then cured at 23° C. for 7 days.
6) Before detaching test, samples were heated in an oven for 10 mins at 80° C.
7) Samples were then removed and fixed by bend clamp, while a screwdriver was used to manually pry the substrates apart. Detachment under 1 minute is regarded as “successful.” “Failure” was indicated by two modes: cohesive failure (adhesive on both sides after detaching) and adhesive failure (adhesive on one side after detaching).

### EXAMPLES

The following examples are provided to illustrate the embodiments of the invention, but are not intended to limit the scope thereof. All parts and percentages are by weight unless otherwise indicated. Table 2 lists the materials used in the following examples:

TABLE 2
Component chemicals used in the examples

| | | Melting | |
|---|---|---|---|
| | | point | |
| Component | Description | (° C.) | Supplier |
| MAH-g-CPO | Maleic anhydride grafted chlorinated | 70 | Toyobo |
| | polyolefin (20 wt % Cl, 1.6 wt % MAH, Mw | | |
| | 75,000) | | |
| EVA-1 | Ethylene-vinyl acetate (EVA, 40% VA) | 58 | Dow |
| EVA-2 | Ethylene-vinyl acetate (EVA, 28% VA) | 70 | Dow |
| MAH-g-EVA-1 | Maleic anhydride grafted ethylene-vinyl | 71 | Dow |
| | acetate (>1% MAH) | | |
| MAH-g-EVA-2 | Maleic anhydride grafted ethylene-vinyl | 74 | Dow |
| | acetate (0.25-0.5% MAH) | | |
| MAH-g-POE | Maleic anhydride grafted polyolefin (>0.5%- | 62.7 | Dow |
| | MAH) | | |
| MAH-g-SEBS | Maleic anhydride grafted Styrene-ethylene- | <75 | Kraton |
| | butylene-styrene (1.4-2.0% MAH) | | |
| TPU | Thermoplastic polyurethane | 73 | Huafon |
| PET | Thermoplastic Polyethyleneterephthalate | <70 | Bester |
| Hydrogenated | acid number mg KOH/g = 160; | 72 | Fushan Baolin |
| rosin | dehydroabietic acid = 10%; | | Chemical |
| | CAS number: 65997-06-0 | | Industry |
| Gum rosin | acid number mg KOH/g = 166; | 76 | Fushan Baolin |
| | CAS number: 8050-09-7 | | Chemical |
| | | | Industry |
| Methyl | CAS: 108-87-2 | — | Sigma-Aldrich |
| cyclohexane | | | |
| Methyl ethyl | CAS: 78-93-3 | — | Sigma-Aldrich |
| ketone | | | |
| Thermoset PU | Methylene diphenyl diisocyanate | — | Dow |
| | (MDI) based 2K polyurethane structural | | |
| | adhesive | | |

### Example 1: Influence of Type of Primer Resin on Performance

In this example, sample multilayer compositions were prepared on epoxy coated type-3 aluminum substrates, which are first coated by the different type of thermoplastic primer compositions. The substrates are then then bonded with thermoset 2K PU structural adhesive, aged, and tested for cross tensile strength and detachability. For comparison, epoxy coated type-3 substrates without primer treatment were also applied in the test.

Results are summarized in Table 3. Data in parentheses represent example strength decrease percentage compared with control sample without a thermoplastic primer layer at 23° C.

TABLE 3
Adhesion performance for sample thermoplastic
primer compositions in Example 1

| | | | | | Failure |
|---|---|---|---|---|---|
| | Composition | Cross tensile | | Detaching | mode after |
| | of primer | strength (MPa) | | test at | detaching |
| Sample | layer | 23° C. | 90° C. | 80° C. | test |
| CE1 | Control, no | 22 | 3.7 | failure | cohesive |
| | primer layer | | | | |
| IE1 | MAH-g-CPO | 20.2 | 2.3 | success | adhesive |
| | (1.6% MAH) | (−8.2%) | | | |
| CE2 | EVA (40% VA) | 3.7 | 0.1 | — | — |
| | | (−83.2%) | | | |
| CE3 | EVA (28% VA) | 0 | 0 | — | — |
| | | (−100%) | | | |
| CE4 | MAH-g-EVA | 14.6 | 2.5 | — | — |
| | (>1% MAH) | (−33.6%) | | | |
| CE5 | MAH-g-EVA | 5.9 | 0.2 | — | — |
| | (0.25-0.5% | (−73.2%) | | | |
| | MAH) | | | | |
| CE7 | MAH-g-POE | 7.8 | 0.8 | — | — |
| | (>0.5%-MAH) | (−64.5%) | | | |
| CE8 | MAH-g-SEBS | 10.6 | 1.7 | — | — |
| | (1.4-2.0% | (−51.8) | | | |
| | MAH) | | | | |
| CE9 | TPU | 21.7 | 3.2 | failure | cohesive |
| | | (−1.4%) | | | |
| CE10 | PET | 21.9 | 3.5 | failure | cohesive |
| | | (−0.5%) | | | |
| CE11 | Hydrogenated | 18.9 | 2.9 | failure | cohesive |
| | rosin | (−14.1%) | | | |
| CE12 | Gum rosin | 18.7 | 3.4 | failure | cohesive |
| | | (−15.0%) | | | |

Example 1 shows that polarity of the primer resin affects adhesive and detachment properties, particularly, that reducing primer's polar character increases detachment at higher temperatures (e.g., >50° C.) but reduces bonding strength at room temperature, while increasing the polar character of the primer resin (e.g., TPU, PET) maintains room temperature bonding and does not improve the detaching performance at high temperatures.

Regarding CE1, when bonded with a thermoset adhesive without primer treatment, the cross tensile strength of the sample decreases from 22 MPa to 3.7 MPa as the temperature is increased from 23° C. to 90° C. However, detaching test results show an inability to detach and a cohesive failure mode within the thermoset adhesive layer.

Samples CE3-CE8 bonded with less polar thermoplastic resin-based primers and thermoset adhesive shows that cross tensile strength at 23° C. or 90° C. decreases in comparison to CE1, which potentially indicates that the lower polarity of the primer layer compositions negatively affects bonding performance with the polar thermoset adhesive. The decrease in cross tensile strength at 23° C. exceeds 30% for the comparative samples, and indicates that reduced polarity thermoplastic primer layers are poorly compatible with the thermoset adhesive and reduce overall bonding strength to unacceptable levels. In practice, this is evidenced as adhesive failure at the interface of the substrate/primer layer and/or primer layer/adhesive layer, while the adhesive layer remains intact.

Regarding CE9-CE12, samples bonded with polar thermoplastic resin based primers and polar thermoset adhesives are shown in Table 3 as having cross tensile strength at 23° C. and 90° C. comparable with CE1 without primer treatment. CE9-CE12 are characterized by cohesive failure, indicating that the polar thermoplastic resin based primer layer did not increase detachability at high temperature.

Sample IE1 containing MAH-g-CPO-based primer exhibited a minor decrease of cross tensile strength at 23° C. of 8.2% in comparison to CE1 containing no thermoplastic primer layer. At 90° C., however, IE1 exhibits a cross tensile strength of 2.3 MPa (a ˜37% decrease in comparison to CE1) and enabled successful detachment. The reduction of cross tensile strength at elevated temperatures was also correlated with adhesive failure modes. Thus, thermoplastic primer layers incorporating MAH-g-CPO exhibit a balance of polarity with epoxy coated Al and 2K PU thermoset adhesives characterized by suitable bonding properties at low temperatures and detachability at high temperatures.

### Example 2: Influence of Thermoplastic Resin on MAH-g-CPO Based Primer Performance

In the next example, primer layer formulations containing MAH-g-CPO and blends with polymers of varying polarity were tested on epoxy-coated type-3 Al substrates for detachment performance. Samples were prepared essentially as described with respect to Example 1. Data in parentheses represent example strength decrease percentage compared with control sample without primer layers at 23° C.

TABLE 4
Adhesion performance for sample thermoplastic primer compositions in Example 2

| | Composition of | Cross tensile strength | | Detaching | Failure mode |
|---|---|---|---|---|---|
| | resins in | at different temp (MPa) | | test at | after detaching |
| Sample | primer | 23° C. | 90° C. | 80° C. | test |
| CE1 | Control, no primer layer | 22 | 3.7 | failure | cohesive |
| IE2 | 4.5% MAH-g-CPO + | 20.1 | 2.1 | success | adhesive |
| | 0.5% hydrogenated rosin | (−8.6%) | | | |
| IE3 | 3.5% MAH-g-CPO + | 16.5 | 1.6 | success | adhesive |
| | 1.5% hydrogenated rosin | (−25.0%) | | | |
| CE13 | 2.5% MAH-g-CPO + | 14.5 | 1.5 | success | adhesive |
| | 2.5% hydrogenated rosin | (−34.1%) | | | |
| CE14 | 1.5 wt % MAH-g-CPO + | 11.4 | 1.1 | success | adhesive |
| | 3.5 wt % hydrogenated | (−48.2%) | | | |
| | rosin | | | | |
| IE4 | 3.5% MAH-g-CPO + | 18.7 | 2.7 | success | adhesive |
| | 1.5% TPU | (−15.0%) | | | |
| IE5 | 3.5 wt % MAH-g-CPO + | 17 | 2.5 | success | adhesive |
| | 1.5 wt % MAH-g-EVA | (−22.7%) | | | |
| CE15 | 2.5 wt % MAH-g-CPO + | 14.4 | 0.8 | success | adhesive |
| | 2.5 wt % MAH-g-EVA | (−34.5%) | | | |

When different dosages of hydrogen rosins are introduced into MAH-g-CPO based primers, IE2 (4.5 wt % MAH-g-CPO and 0.5 wt % hydrogenated rosin) and IE3 (3.5 wt % MAH-g-CPO and 1.5 wt % hydrogenated rosin) illustrate that inclusion of 0.5 wt % to 1.5 wt % hydrogenated rosins into primer formulations (<50 wt % based on solid of primer) provide acceptable cross tensile strength at room temperature and detachment performance at elevated temperature. Similarly, good adhesion and detachment properties were obtained with 3.5:1.5 mixtures of MAH-g-CPO and TPU (IE4) and MAH-g-CPO and MAH-g-EVA (IE5).

### Example 3: Influence of Substrates on Detaching Performance

In the next example, different substrates (epoxy coated Al, type-3 Al) were coated by the thermoplastic primer composition used for IE3 (3.5 wt % MAH-g-CPO+1.5 wt % hydrogenated rosin), and bonded by 2K PU thermoset adhesive. Samples were prepared essentially as described with respect to Example 1. Lap shear strength, cross tensile strength, and detaching tests were conducted. Results are summarized in Table 5. The cross tensile strength, lap shear strength, and detaching test results indicate detachment on type-3 Al, with easiness of detachment as type-3 Al>epoxy coated Al.

TABLE 5
Adhesion performance for sample thermoplastic primer compositions in Example 3

| | | Primer | | | | | | |
|---|---|---|---|---|---|---|---|---|
| | | 3.5 wt % | Lap shear | | Cross tensile | | | Failure |
| | | MAH-g-CPO + | strength at | | strength at | | | mode |
| | | 1.5 wt % | different temp | | different temp | | Detaching | after |
| | Type of | hydrogenated | (MPa) | | (MPa) | | test at | detaching |
| Sample | substrate | rosin | 23° C. | 80° C. | 23° C. | 80° C. | 80° C. | test |
| CE1 | Epoxy | no | 17.3 | 7.3 | 22 | 4.3 | failure | cohesive |
| IE3 | coated | yes | 15.3 | 2.3 | 16.5 | 1.6 | success | adhesive |
| | Al | | (−11.6%) | | (−25.0%) | | | |
| CE1 | 3-type | no | 13.6 | 3.9 | 17.4 | 2.2 | failure | cohesive |
| IE3 | Al | yes | 12.4 | 1.6 | 15.9 | 1.4 | success | adhesive |
| | | | (−8.8%) | | (−8.6%) | | | |

### Example 4: Influence of Thickness of Primer Layer on Performance

In this example, samples were assayed having varied thickness of the solid thermoplastic primer layer on an epoxy-coated Al substrate that was then bonded by thermoset adhesive. Thermoplastic primer layer thickness was controlled by altering solids content and/or use of multiple layers of thermoplastic primer. Samples were prepared essentially as described with respect to Example 1. The results are summarized in Table 6.

TABLE 6
Adhesion performance for sample thermoplastic
primer compositions in Example 4

| | Thickness | Lap shear | | Cross tensile | | | |
|---|---|---|---|---|---|---|---|
| | of primer | strength at | | strength at | | | Failure |
| | layer after | different temp. | | different temp | | Detaching | mode after |
| | dried | (MPa) | | (MPa) | | test at | detaching |
| Samples | (um) | 23° C. | 80° C. | 23° C. | 80° C. | 80° C. | test |
| CE1 | Control, | 20.5 | 6.3 | 17.6 | 3.3 | failure | cohesive |
| | no primer | | | | | | |
| | layer | | | | | | |
| CE16 | 6 | 5 | 0.9 | 4.4 | 0.5 | success | adhesive |
| | | (−75.6%) | | (−75.0%) | | | |
| CE17 | 8 | 9.1 | 1.4 | 9.5 | 0.9 | success | adhesive |
| | | (−55.6%) | | (−49.1%) | | | |
| IE6 | 11 | 14.5 | 1.7 | 13.1 | 1.6 | success | adhesive |
| | | (−29.3%) | | (−26.1%) | | | |
| IE7 | 13 | 16.1 | 2.3 | 14.3 | 1.7 | success | adhesive |
| | | (−21.5%) | | (−20.5%) | | | |
| IE8 | 27 | 18.3 | 2.3 | 14.5 | 1.8 | success | adhesive |
| | | (−10.7%) | | (−17.6%) | | | |
| IE9 | 40 | 16.9 | 3.1 | 12.7 | 1.3 | success | adhesive |
| | | (−17.6%) | | (−27.8%) | | | |
| CE18 | 80 | 15.2 | 1.9 | 4.2 | 0.2 | success | adhesive |
| | | (−25.8%) | | (−76.1%) | | | |

Note:
the thickness of the primer layer after dried is controlled by different solid content of primers in the test or by coating times.

Example 4 illustrates that, compared to CE1 without primer treatment, both of lap shear strength and cross tensile strength of CE16 and CE17 were decreased when the thickness of the dried thermoplastic primer layer was less than 10 μm. However, when the thickness of the dried thermoplastic primer layer is over 10 μm, the performances of IE6-IE9 met the targeted adhesive and detachment performance. However, the selected multilayer compositions show an upper limit in effectiveness at higher layer thicknesses. For example, when the thickness of the dried solid primer layer is around 80 μm, CE18 data show the cross tensile strength at room temperature decreases by 76.1% compared with CE-1 without the thermoplastic primer layer

While the foregoing is directed to exemplary embodiments, other and further embodiments may be devised without departing from the basic scope thereof, and the scope thereof is determined by the claims that follow.

1. A multilayer composition, comprising:
a substrate having a surface energy of 35 dynes/cm or greater;
one or more thermoplastic primer layers comprising 55 wt % to 100 wt % of a maleic anhydride grafted chlorinated polyolefin and a glass transition temperature in the range of 50° C. to 120° C.; and one or more thermoset adhesive layers.

2. The multilayer composition of claim 1, wherein the maleic anhydride grafted chlorinated polyolefin has a maleic anhydride grafting degree of greater than 1% and a chlorination degree content of greater than 10%.

3. The multilayer composition of claim 1, wherein the maleic anhydride grafted chlorinated polyolefin has glass transition temperature from 60° C. to 80° C.

4. The multilayer composition of claim 1, wherein the one or more thermoplastic primer layers further comprise one or more additional thermoplastic polymers at a percent by weight (wt %) up to 45 wt %, and wherein the one or more thermoplastic primer layers has a glass transition temperature from 50° C. to 100° C.

5. The multilayer composition of claim 1, wherein the one or more thermoplastic primer layers further comprise one or more additional thermoplastic polymers selected from maleic anhydride grafted polyolefin (MAH-g-POE), polyolefin (POE), maleic anhydride grafted ethylene-vinyl acetate (MAH-g-EVA), ethylene-vinyl acetate (EVA), maleic anhydride grafted styrene-ethylene-butylene-styrene (MAH-g-SEBS), hydrogenated rosin, thermoplastic polyurethane (TPU), or polyester (PET).

6. The multilayer composition of claim 1, wherein the cross tensile strength of the multilayer composition has less than a 30% decrease at 23° C. relative to a comparative multilayer composition without the one or more thermoplastic primer layers.

7. A method of detaching the multilayer composition of claim 1, comprising: heating the multilayer composition to a temperature greater than 50° C.; and removing at least one of the layers of the multilayer composition.

8. An electric vehicle battery assembly comprising the multilayer composition of claim 1.
